(19) United States
(12) Patent Application Publication
(10) Pub. No.: US 2013/0298523 A1
(43) Pub. Date: Nov. 14, 2013

(54) CONSTANT PRESSURE AEROSPIKE THRUSTER

(71) Applicant: Joseph D. Sims, Huntsville, AL (US)

(72) Inventor: Joseph D. Sims, Huntsville, AL (US)

(21) Appl. No.: 12/705,362

(22) Filed: Feb. 12, 2010

Related U.S. Application Data
(60) Provisional application No. 61/152,115, filed on Feb. 12, 2009.

(51) Int. Cl. F02K 1/00

(52) U.S. Cl. CPC F02K 1/00
USPC 60/200.1

(57) ABSTRACT

A constant pressure aerospike thruster has been developed. The aerospike thruster includes a hollow combustion chamber with a circular shaped throat area, a spring loaded pintle located inside the combustion chamber and a spike extended out from the pintle through the throat area.

### CROSS-REFERENCE TO RELATED APPLICATIONS

This application claims priority from U.S. Provisional Patent Application No. 61/152,115 titled “Constant Pressure Aerospike Thruster” that was filed on Feb. 12, 2009.

### FIELD OF THE INVENTION

The invention relates generally to propulsion systems for rocket engines. More specifically, the invention relates to a thruster to provides constant pressure.

### BACKGROUND ART

Design crtieria for missile and rocket systems have resulted in an increased emphasis on throttling propulsion systems, increased performance and maximum mission flexibility. This includes the ability to turn on and off the propulsion system to meet mission-specific goals. Pintles, both in the throat and the injector of various systems, are often used to provide throttling capability. Liquid and/or gel propulsion systems are likewise often cited as providing the maximum mission flexibility since the thrust-time curve is highly tailorable. The systems also have the highest performance from a pure Iₛₚ standpoint. Consequently, a need exists for a system to improve the throttling capability of missile and rocket systems.

### SUMMARY OF THE INVENTION

In some aspects, the invention relates to an aerospike thruster, comprising: a hollow combustion chamber with a circular shaped throat area; a spring loaded pintle located inside the combustion chamber; and a spike extended out from the pintle through the throat area.

In other aspects, the invention relates to an aerospike thruster, comprising: a hollow combustion chamber with a circular shaped throat area; a pintle located inside the combustion chamber; a spike extended out from the pintle through the throat area; and means for adjusting the throat area to maintain a constant specific impulse (Iₛₚ) value for the aerospike thruster.

Other aspects and advantages of the invention will be apparent from the following description and the appended claims.

### BRIEF DESCRIPTION OF DRAWINGS

It should be noted that identical features in different drawings are shown with the same reference numeral.

FIG. 1a shows a cross-sectional view of a CPAT combustor at the highest thrust throttle point (i.e., no pintle-aerospike extension) in accordance with one embodiment of the present invention.

FIG. 1b shows a cross-sectional view of a CPAT combustor at the lowest thrust throttle point (i.e., complete pintle-aerospike extension) in accordance with one embodiment of the present invention.

### DETAILED DESCRIPTION

A Constant Pressure Aerospike Thruster (CPAT) has been developed. The essence of the CPAT is to use a throat pintle that is precisely contoured along its length. In rocketry, a pintle engine uses a single-feed fuel injector rather than the hundreds of smaller holes used in a typical rocket engine. The pintle is located downstream of the combustor throat plane such that it replaces the more traditional bell-shaped nozzle.

Such a pintle is used with an “aerospike” that is a well-known design solution for rocket combustors. The aerospike engine is a type of rocket engine that maintains its aerodynamic efficiency across a wide range of altitudes through the use of an aerospike nozzle. It is a member of the class of altitude compensating nozzle engines. A vehicle with an aerospike engine typically uses 25-30% less fuel at low altitudes, where most missions have the greatest need for thrust. Aerospike engines have been studied for a number of years and are the baseline engines for many single-stage-to-orbit (SSTO) designs. The aerospike is fired along the outside edge of a protrusion, the “spike”. The spike forms one side of a virtual bell, with the other side being formed by the outside air—thus the “aerospike”.

The idea behind the aerospike design is that at low altitude the ambient pressure compresses the wake against the nozzle. The recirculation in the base zone of the wedge can then raise the pressure there to near ambient. Since the pressure on top of the engine is ambient, this means that base gives no overall thrust (but it also means that this part of the nozzle doesn't lose thrust by forming a partial vacuum, thus the base part of the nozzle can be ignored at low altitude).

As the spacecraft climbs to higher altitudes, the air pressure holding the exhaust against the spike decreases, but the pressure on top of the engine decreases at the same time, so this is not detrimental. Further, although the base pressure drops, the recirculation zone keeps the pressure on the base up to a fraction of 1 bar, a pressure that is not balanced by the near vacuum on top of the engine; this difference in pressure gives extra thrust at altitude, contributing to the altitude compensating effect. This produces an effect like that of a bell that grows larger as air pressure falls, providing altitude compensation.

Several versions of the design exist, differentiated by their shape. In the toroidal aerospike, the spike is bowl-shaped with the exhaust exiting in a ring around the outer rim. In theory this requires an infinitely long spike for best efficiency, but by blowing a small amount of gas out the center of a shorter truncated spike, something similar can be achieved.

In the present invention, a passive, spring-loaded (not shown) pintle from a constant pressure thruster (CPT) engine is combined with the aerospike extension. This allows the system to maintain independence between chamber pressure and propellant flowrate. The end result is a combustor that delivers nearly constant specific impulse (Iₛₚ) at any throttle setting and at any altitude.

Specific impulse is a way to describe the efficiency of rocket and jet engines. It represents the impulse—change in momentum—per unit of propellant. When referring to the specific impulse it just means to divide the impulse by the unit mass or unit weight. The higher the specific impulse, the less propellant is needed to gain a given amount of momentum.

In rocketry, where the only reaction mass is the propellant, specific impulse is defined as the change in momentum per unit weight-on-Earth of the propellant:

Iₛₚ=vₑ/g₀

where
Iₛₚ is the specific impulse measured in seconds;
vₑ is the average exhaust speed along the axis of the engine in (ft/s or m/s); and
g₀ is the acceleration at the Earth's surface (in ft/s² or m/s²)

A throat pintle has been used to maintain a constant chamber pressure through an 11;1 throttle ratio for a constant pressure gel rocket engine also called a constant pressure thruster (CPT). The constant chamber pressure allows the nozzle to operate at its design pressure ratio at every throttle setting, which resulted in Iₛₚ performance that was practically independent of thrust level.

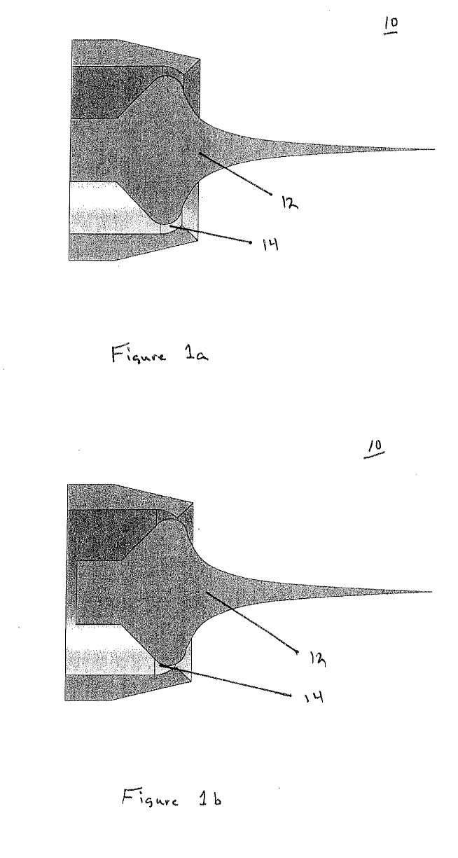

The CPAT combines the passively controlled pintle of the CPT with a properly contoured exhaust spike upon which the combustion gases are expanded to produce thrust. FIG. 1a shows a cross-sectional view of a CPAT combustor 10 at the highest thrust throttle point. In this example, there is no pintle-aerospike 12 extension. In comparison, FIG. 1b shows a cross-sectional view of the CPAT combustor 10 at the lowest thrust throttle point. In this example, there is complete pintle-aerospike 12 extension.

The contour of the pintle 12 upstream of the throat region 14 is such that axial movement of the pintle causes a change in flow area at the throat region. Specifically, axial movement to the right (as shown in reference to FIGS. 1a and 1b) results in pintle extension and gives lower throat area. Conversely, movement to the left gives higher throat area a results in pintle retraction. The special aerospike contour downstream of the throat, regardless of the amount of extension or retraction of the device, maintains the ability to respond to ambient pressure, just as a fixed, immobile aerospike contour.

In summary, the present inventions is a deeply throttleable engine that passively maintains nearly constant Iₛₚ performance regardless of altitude or thrust level. Other advantages include the ability to contour the portion of the pintle that is entirely inside the combustor such that some or all of the thrust forces developed on the aerospike contour are balanced.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. An aerospike thruster, comprising:
a hollow combustion chamber with a circular shaped throat area;
a spring loaded pintle located inside the combustion chamber; and
a spike extended out from the pintle through the throat area.

2. The aerospike thruster of claim 1, where the spring loaded pintle maintains a chamber pressure to throttle ratio of 11:1 in the combustion chamber.

3. The aerospike thruster of claim 1, where the spring loaded pintle maintains a constant specific impulse (Iₛₚ) value for the aerospike thruster at any altitude.

4. The aerospike thruster of claim 1, where the spring loaded pintle maintains a constant specific impulse (Iₛₚ) value for the aerospike thruster at any thrust level.

5. The aerospike thruster of claim 1, where the spring loaded pintle maintains a balance of thrust forces on the spike.

6. The aerospike thruster of claim 1, where the spike is toroidal shaped.

7. An aerospike thruster, comprising:
a hollow combustion chamber with a circular shaped throat area;
a pintle located inside the combustion chamber;
a spike extended out from the pintle through the throat area; and
means for adjusting the throat area to maintain a constant specific impulse (Iₛₚ) value for the aerospike thruster.
